(19) United States
(12) Patent Application Publication
(10) Pub. No.: US 2009/0244618 A1
(43) Pub. Date: Oct. 1, 2009

(54) IMAGE PROCESSING APPARATUS AND IMAGE SELECTION METHOD

(75) Inventors: Kei Yamaji, Ashigarakami-gun (JP); Yuji Takamatsu, Ashigarakami-gun (JP); Masaki Saitou, Ashigarakami-gun (JP); Hitoshi Yamazaki, Ashigarakami-gun (JP); Kouichi Tanimura, Ashigarakami-gun (JP); Takafumi Matsushita, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/414,418

(22) Filed: Mar. 30, 2009

(30) Foreign Application Priority Data
Mar. 31, 2008 (JP) 2008-093095

(51) Int. Cl. G06F 3/12; G06F 3/041

(52) U.S. Cl. 358/1.15; 345/173

(57) ABSTRACT

An aspect of the present invention provides an image processing apparatus, comprising: a monitor which displays various information; an input device with which a user performs an input operation; an identification device which identifies the user who has performed the input operation with the input device; an image reading device which reads images; an image selection device which, according to the input operation with the input device, selects an image which is a predetermined processing target, from the images read by the image reading device, the image selection device identifying a plurality of users who have performed input operations for selecting images, by the identification device, and selecting the image which is the processing target, for each of the users who have performed the input operations for selecting the images; and a processing device which executes a process with the image selected by the image selection device as the processing target.

### BACKGROUND OF THE INVENTION

1. Field of the Invention

The present invention relates to an image processing apparatus and an image selection method, and more particularly, to an image processing apparatus and an image selection method which are applied to a print ordering apparatus for digital images or the like.

2. Description of the Related Art

Currently, there has been provided a print service in which digital images shot by a digital camera or the like can be ordered to be printed, or can be printed in a print ordering apparatus deployed within or in front of a DPE shop or a laboratory shop, within various commercial facilities, or the like.

According to this service, when a print ordering person (user) loads a recording medium (memory card or the like) in which an image desired to be printed has been saved, into the print ordering apparatus, or connects the digital camera or a cellular phone in which such a recording medium has been loaded or built, to the print ordering apparatus, an order guidance screen is displayed on a monitor. Then, according to the order guidance screen, an image which is designated to be printed is selected, and order information on designation of a print size or the number of prints, or the like is inputted. On completion of an ordering operation, the image designated to be printed is transmitted to a printer within the shop or the like and is printed, or is printed by a printing apparatus embedded in the print ordering apparatus, and a printed photo is given to the user in exchange for a fee.

Moreover, a touch panel has been installed on the monitor of the print ordering apparatus as described above, and the order information can be typically inputted by a touch operation with respect to a monitor screen.

Japanese Patent Application Laid-Open No. 2006-34754 has proposed a technique of controlling characters appearing in a game by touch operations at multiple points on a multi-touch panel on which indicated positions at the multiple points can be simultaneously detected.

Japanese Patent Application Laid-Open No. 2007-89732 has proposed a technique of enabling different fingers, or input operations performed by a plurality of persons, to be identified by detecting fingerprints of fingers which have touched a touch panel.

### SUMMARY OF THE INVENTION

Incidentally, the print ordering apparatus accepts a print order from each user, one by one. Therefore, if a plurality of users make print orders in one apparatus, there is a problem in that those users cannot simultaneously make the print orders as their own orders, respectively.

In other words, in such a case, each print order is required to be made by one user at a time in order, or one user is required to make the print orders also for others, as the user's own order.

If each print order is made by one user at a time in order, even for a print order in which an image to be printed is selected from common images, each user needs to perform all operations required for the print order, separately, which causes a problem of requiring wasteful efforts and time.

On the other hand, if one user makes the print orders also for others, as the user's own order, there is a problem of confusion caused by the input operation performed freely by each user. Moreover, in the middle of inputting print order information, each user cannot comprehend his own image designated to be printed and an image which has not been designated to be printed, and unforeseen circumstances are likely to arise in which the number of prints of finished prints does not match the order or the like if the print order information has been corrected or the like. Furthermore, since the prints are made as the order from one user, only a total amount required for the prints for all users can be comprehended, which causes a problem in that the users have to calculate the fee to be paid by each user, by themselves. There is also a problem of requiring a task of sorting received prints for each user.

The present invention has been made in view of circumstances as described above, and it is an object of the present invention to provide an image processing apparatus and an image selection method in which, in the case where a plurality of users select images in one apparatus, each of those users can simultaneously and preferably select his own image.

In order to achieve the above described object, an image processing apparatus according to a first aspect of the present invention comprises a monitor which displays various information; an input device with which a user performs an input operation; an identification device which identifies the user who has performed the input operation with the input device; an image reading device which reads images; an image selection device which, according to the input operation with the input device, selects an image which is a predetermined processing target, from the images read by the image reading device, the image selection device identifying a plurality of users who have performed input operations for selecting images, by the identification device, and selecting the image which is the processing target, for each of the users who have performed the input operations for selecting the images; and a processing device which executes a process with the image selected by the image selection device as the processing target.

According to the present invention, each of the plurality of users can simultaneously select the image which is the predetermined processing target, as his own processing target.

In the image processing apparatus according to a second aspect of the present invention, in the invention according to the first aspect, the process with the image selected for each of the users as the processing target is divided and executed for each user.

According to the second aspect, since the process is divided and executed for each user, for example, subsequent processes or services for the users can be performed for each user.

In the image processing apparatus according to a third aspect of the present invention, in the invention according to the first or second aspect, at the time of an input operation with respect to an image selected by a predetermined user, the input operation by a user other than the predetermined user is disabled or limited to certain operation contents.

According to the third aspect, confusion can be prevented from being caused by an operation performed by another user at the time of the input operation with respect to the image selected by the predetermined user.

In the image processing apparatus according to a fourth aspect of the present invention, in the invention according to the first, second or third aspect, if each user needs to perform the input operation separately, information which has been already inputted with respect to some of the users is transmitted to another image processing apparatus which is not currently used, and the input operations by the some of the users are executed in another image processing apparatus.

According to the fourth aspect, an operation time can be reduced.

In the image processing apparatus according to a fifth aspect of the present invention, in the invention according to the first, second, third or fourth aspect, operations by the plurality of users can be canceled for each user.

According to the fifth aspect, each user can cancel his own operation without wasting the operations by other users.

The image processing apparatus according to a sixth aspect of the present invention, in the invention according to the first, second, third, fourth or fifth aspect, further includes, as the input device, a touch panel which is installed on a screen of the monitor and detects a touch operation with respect to the screen of the monitor.

The sixth aspect shows an example of an input apparatus.

In the image processing apparatus according to a seventh aspect of the present invention, in the invention according to the first, second, third, fourth, fifth or sixth aspect, the processing device executes a process of accepting a print order for the image selected by the image selection device.

The seventh aspect shows an aspect in which the image processing apparatus according to the present invention is applied to a print ordering apparatus in which the print order is made.

An image selection method according to an eighth aspect of the present invention is an image selection method in an image processing apparatus including a monitor which displays various information, an input device with which a user performs an input operation, an identification device which identifies the user who has performed the input operation with the input device, an image reading device which reads images, an image selection device which, according to the input operation with the input device, selects an image which is a predetermined processing target, from the images read by the image reading device, and a processing device which executes a process with the image selected by the image selection device as the processing target, wherein, at the time of selecting the image by the image selection device, a plurality of users who have performed input operations for selecting images are identified by the identification device, and the image which is the processing target is selected for each of the users who have performed the input operations for selecting the images.

In the image selection method according to a ninth aspect of the present invention, in the invention according to the eighth aspect, the process with the image selected for each of the users as the processing target is divided and executed for each user.

In the image selection method according to a tenth aspect of the present invention, in the invention according to the eighth or ninth aspect, at the time of an input operation with respect to an image selected by a predetermined user, the input operation by a user other than the predetermined user is disabled or limited to certain operation contents.

In the image selection method according to an eleventh aspect of the present invention, in the invention according to the eighth, ninth or tenth aspect, if each user needs to perform the input operation separately, information which has been already inputted with respect to some of the users is transmitted to another image processing apparatus which is not currently used, and the input operations by the some of the users are executed in another image processing apparatus.

In the image selection method according to a twelfth aspect of the present invention, in the invention according to the eighth, ninth, tenth or eleventh aspect, operations by the plurality of users can be canceled for each user.

The image selection method according to a thirteenth aspect of the present invention, in the invention according to the eighth, ninth, tenth, eleventh or twelfth aspect, further includes, as the input device, a touch panel which is installed on a screen of the monitor and detects a touch operation with respect to the screen of the monitor.

In the image selection method according to a fourteenth aspect of the present invention, in the invention according to the eighth, ninth, tenth, eleventh, twelfth or thirteenth aspect, the processing device executes a process of accepting a print order for the image selected by the image selection device.

The invention according to the eighth to fourteenth aspects is a method invention corresponding to the image processing apparatus according to the first to seventh aspects, and provides operations and advantages similar to the invention according to the first to seventh aspects.

According to the present invention, in the case where the plurality of users select the images in one apparatus, each of those users can simultaneously and preferably select his own image.

### BRIEF DESCRIPTION OF THE DRAWINGS

FIG. 1 is an external view showing an embodiment of a print ordering apparatus applied with the present invention;

FIG. 2 is a block diagram of a signal processing system of the print ordering apparatus applied with the present invention;

FIG. 3 is a flowchart illustrating a series of print ordering procedures in the print ordering apparatus applied with the present invention;

FIG. 4 is a diagram illustrating an image selection screen;

FIG. 5 is a diagram illustrating an enlarged portion of the image selection screen;

FIG. 6 is a diagram illustrating a service selection screen;

FIG. 7 is a diagram illustrating a series of operations in the case where two users have selected a specific service; and

FIG. 8 is a system configuration diagram illustrating a system in which images saved in a file server can be ordered in the print ordering apparatus.

### DETAILED DESCRIPTION OF THE PREFERRED EMBODIMENTS

Hereinafter, according to the accompanying drawings, a best mode for carrying out an image processing apparatus and an image selection method according to the present invention will be described in detail.

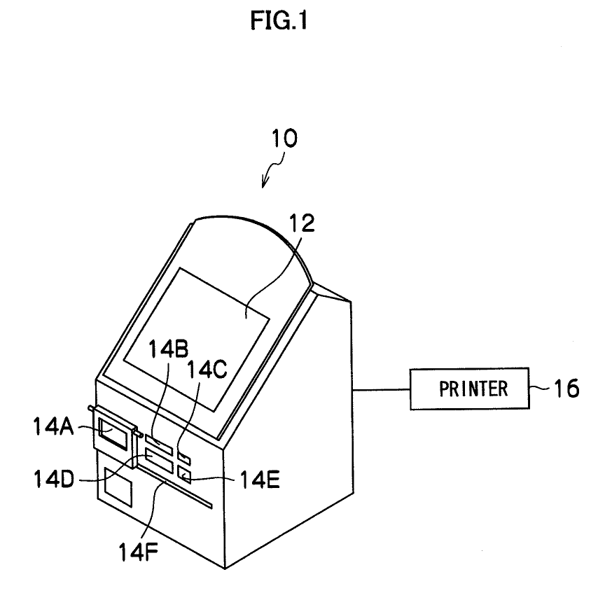

FIG. 1 is an external view showing an embodiment of a print ordering apparatus applied with the present invention. As shown in FIG. 1, a print ordering apparatus 10 of the present embodiment includes a monitor 12 with a touch panel, which performs various displays and also accepts various inputs for print orders, and a plurality of slots 14A to 14F in which various media and a digital camera including a medium having recorded therein images are loaded. The print ordering apparatus 10 is connected to a printer 16 which prints out the images. It should be noted that, while the printer 16 is directly connected to the print ordering apparatus 10 in FIG. 1, the printer 16 may be located in another place separate from the print ordering apparatus 10, and the printer 16 may be connected to the print ordering apparatus 10 via a network, another device or the like. Moreover, the slot 14A is a slot for the digital camera including the medium.

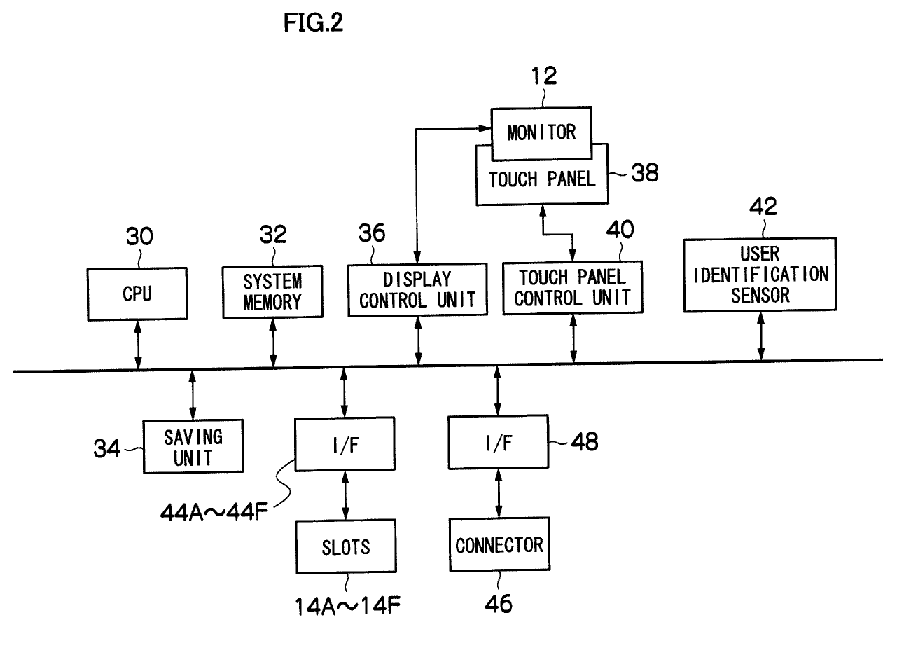

FIG. 2 is a block diagram of a signal processing system of the above described print ordering apparatus 10. As shown in FIG. 2, the print ordering apparatus 10 of the present embodiment includes a CPU 30 which controls operations of the print ordering apparatus 10, a system memory 32 including a ROM which stores a program executed by the CPU 30 and a RAM which becomes a work area, and a saving unit 34 such as a hard disk, which temporarily saves the images read from the medium. It should be noted that the images saved in the saving unit 34 are erased from the saving unit 34 when a certain period has elapsed from the saving.

Moreover, the above described monitor 12, a display control unit 36 which controls the displays on the monitor 12, a touch panel 38 which performs the various inputs via the monitor 12, a touch panel control unit 40 which controls the touch panels 38, a user identification sensor 42 which identifies a user who has touched the touch panel 38, interfaces 44A to 44F corresponding to the respective slots 14A to 14F, a connector 46 which connects the printer 16, and an output interface 48 connected to the connector 46 are included.

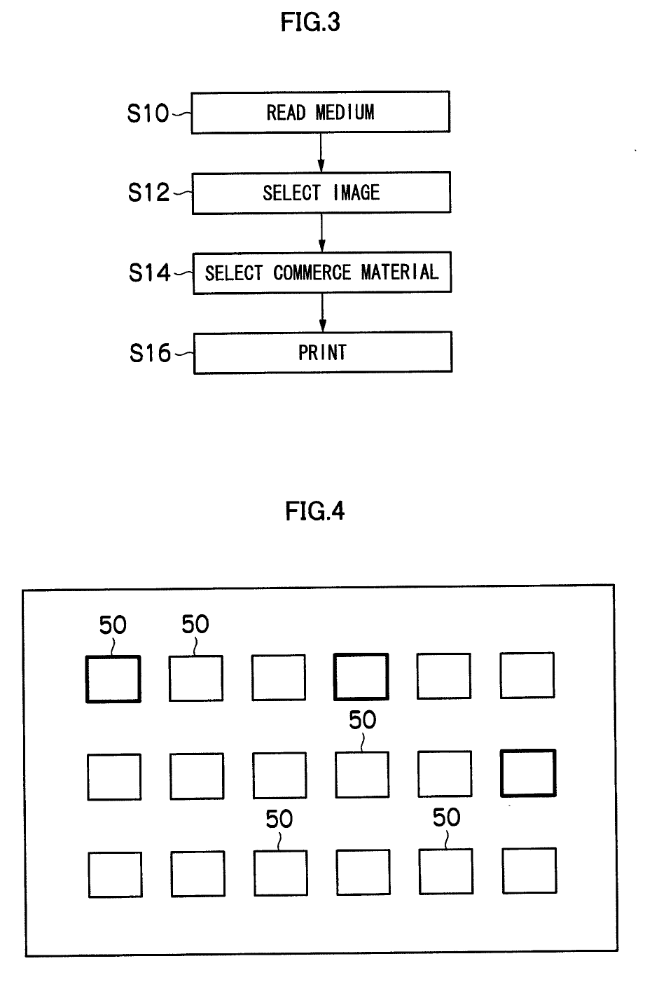

FIG. 3 is a flowchart illustrating a series of print ordering procedures in the above described print ordering apparatus 10.

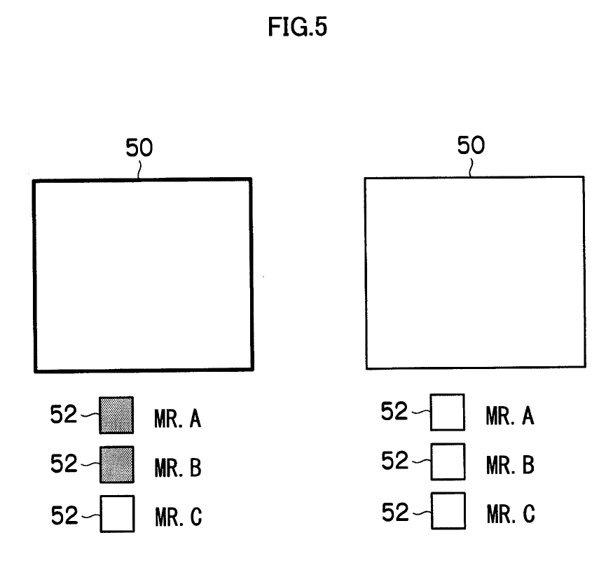

First, when the user (print ordering person) mounts a predetermined medium having recorded therein an image (image data) desired to be printed, or a digital camera in which the medium has been loaded, into a corresponding one of the slots 14A to 14F, the images (hereinafter, referred to as “shot images”) within the medium are read into the saving unit 34 via one of the interfaces 44A to 44F, which corresponds to the slot (step S10). Then, a list of thumbnails (reduced images) of the saved images read into the saving unit 34 is displayed on the monitor 12 via the display control unit 36, and an image selection screen on which a shot image to be printed is selected is displayed as shown in FIG. 4. In FIG. 4, reference numerals 50, 50, . . . designate the shot images (the thumbnails of the shot images). Here, the user selects the shot image to be printed (step S112). Moreover, in the present embodiment, detailed print order information such as a print size and the number of prints, on a shot image designated to be printed, is inputted after the selection on this image selection screen is completed.

Next, the user selects a commerce material on which the shot image designated to be printed is outputted (step S14). For example, in addition to a service in which the shot image designated to be printed is merely printed on a photo paper sheet, there are a service in which the shot image designated to be printed is synthesized with a desired frame image (template image) and printed on the photo paper sheet, a service in which the image designated to be printed is printed on a paper sheet for a photo book, and the like. The user selects which service (commerce material) is desired. Then, according to an order guidance screen displayed depending on the selected service, the user inputs necessary information.

The print ordering apparatus 10 outputs each shot image designated to be printed, to the printer 16 connected to the connector 46, via the output interface 48, and causes the printer 16 to accomplish the print depending on print order contents inputted by the user (step S16).

Next, an embodiment of the image selection in which the image to be printed is selected will be described. In the image selection (step S12) of FIG. 3, the CPU 30 in the print ordering apparatus 10 causes the monitor 12 to display the image selection screen as shown in FIG. 4, via the display control unit 36. On this image selection screen, the list of the thumbnails of the shot images recorded and saved in the medium is displayed.

When the user touches a display section of any shot image on the image selection screen, a touched position is detected by the touch panel 38 installed on a screen surface of the monitor 12, and the touch panel control unit 40 which is a control unit thereof, and a signal indicating the position is given to the CPU 30.

The CPU 30 determines which shot image has been selected, based on a relationship between a position of each shot image displayed on the monitor 12 and the touched position on the touch panel 38, and sets the touched shot image as the image to be printed. It should be noted that if the shot image which has already been designated to be printed is touched again, the print designation is canceled. Moreover, a frame of the shot image designated to be printed is displayed, for example, as a frame of a color different from that of a shot image which has not been designated to be printed, and the shot image designated to be printed and the shot image which has not been designated to be printed are identifiably displayed.

In this way, the user can select the image to be printed, by touching the display section of the shot image desired to be printed, on the image selection screen displayed on the monitor 12.

Moreover, in the print ordering apparatus 10 of the present embodiment, a plurality of users can select the shot images to be printed, as their own print orders, respectively, and who has touched the screen of the monitor 12 can be identified by the user identification sensor 42.

As an example of the user identification sensor 42, the technique of Japanese Patent Application Laid-Open No. 2007-89732 as illustrated in the section of “Description of the Related Art” can be applied. In other words, a fingerprint of a finger which has touched the screen is detected.

According to this technique, if any of the users has touched the screen, a fingerprint at that time is detected by the user identification sensor 42. If the fingerprint has been detected for the first time, the fingerprint is stored as that of one user, and also the user is registered as one print ordering person.

On the other hand, if the fingerprint detected by the user identification sensor 42 matches a fingerprint which has been already stored, that touch operation is determined to have been performed by the user with the stored fingerprint. Thereby, if any of the users has touched the screen, the user is identified.

It should be noted that, in order to display the print order contents or the like for each user, and also in order for the user himself to comprehend which user the user has been identified as in the print ordering apparatus 10, when the user has been registered, a suitable user name (pseudonym: for example, a pseudonym such as Mr. A, Mr. B or Mr. C) may have been assigned and notified to the user.

Moreover, before a print ordering operation is started, all users scheduled to make the print orders may have been instructed to touch the screen in order so that the fingerprint of each user may have been stored and also the suitable user name may have been assigned and notified to each user.

As another example of the user identification sensor 42, a method is conceivable in which a weak current has been set to flow through the user when each user scheduled to make the print order has touched the screen of the monitor 12, and the user through which the weak current has flowed has been set to be detected. For example, a detection circuit has been configured for each user so that a part of a closed circuit through which the weak current flows is the user who has touched the screen of the monitor 12, and the detection circuit has been set to be opened when the user is not touching the screen so that the current does not flow. In other words, the screen of the monitor 12 has been set as one electrode of each detection circuit, and the other electrode thereof has been connected to a part of a body of each user (a part other than a hand operating the screen). For example, the electrode of each detection circuit may have been provided at an arbitrary section of the print ordering apparatus 10 or the like, and each user may have been instructed to touch another electrode with a hand other than the hand operating the screen. Alternatively, the electrode of each detection circuit may have been provided at each chair on which each user sits, and the electrode may have been set to be connected to each user when the user has sat on the chair.

Then, when any of the users has touched the screen of the monitor 12 and the weak current has flowed through the detection circuit with the user as its part, the user who has touched the screen can be identified by identifying the detection circuit through which the weak current has flowed.

It should be noted that, in order to display the print order contents or the like for each user, and also in order for the user himself to comprehend which user the user has been identified as in the print ordering apparatus 10, the suitable user name (pseudonym: for example, Mr. A, Mr. B or Mr. C) may have been assigned to the electrode which is constantly connected to the user so that the user can know the user name.

Moreover, instead of causing the weak current to flow through a human body when the user has touched the screen as described above, a plurality of buttons with user names may be provided, and each user may decide his own user name and press the button of his own user name when each user touches the screen. The user identification sensor 42 is assumed to detect ON/OFF of the button, and can identify the user who has touched the screen, depending on which button has been turned on when the screen has been touched.

Furthermore, a plurality of input apparatuses with which the users perform input operations may have been prepared, and the respective users may use different input apparatuses so that the user who has performed the input operation may be identified.

As described above, in the case where the plurality of users who make the print orders are automatically identified by the user identification sensor 42, even if those users have simultaneously touched the screen, in order to enable those operations to be detected, the touch panel 38 has preferably been a multi-touch panel so that a plurality of input operations can be simultaneously detected.

Moreover, as a method which enables the print orders from the plurality of users, a method without using the user identification sensor 42 as described above is also conceivable. In other words, when each user touches the screen, or before each user touches the screen, the user can also be caused to previously touch a display section at which the user is designated on the monitor 12. For example, buttons with the user names such as “Mr. A”, “Mr. B” and “Mr. C” have been displayed on the screen of the monitor 12. Each user may have decided which user name is owned by the user himself, and when operating the screen for his own print order, the user may touch the button of his own user name simultaneously with the operation or before the operation.

In this way, in the case where the operations on the screen by the plurality of users can be identified and the respective users can select the shot images to be printed as their own print orders, respectively, the image selection screen as shown in FIG. 4 performs the display so that the user who has selected the image as the image to be printed can be known. For example, as shown in FIG. 5 with an enlarged portion of the image selection screen, under the respective shot images 50 and 50, or the like, check boxes 52, 52, . . . which display whether or not the respective users have selected the respective shot images may be displayed along with the user names (Mr. A, Mr. B, Mr. C and the like). Moreover, the shot image designated to be printed by any of the users may be displayed in the color different from that of the frame of the shot image which has not been designated to be printed, and the color of the frame may be a color assigned to the user who has performed the print designation. In this case, if the plurality of users have designated the same shot image to be printed, for example, a multi-frame may be displayed with a plurality of colors corresponding to the respective users.

Next, an embodiment related to a process of the print (step S16) of FIG. 3 in the case where the plurality of users can select the shot images to be printed as their own print orders, respectively, as described above will be described.

In the case where the plurality of users have selected the shot images to be printed as their own print orders, respectively, if those shot images are printed without being distinguished from one another, after the users receive finished prints, a task of sorting the finished prints for each user is required to be performed. Consequently, in the present embodiment, the print order information inputted by the plurality of users is handled as order information on different users, and the number of the orders is changed depending on the number of the users. For example, if the plurality of users have selected the shot images to be printed, when the CPU 30 in the print ordering apparatus 10 outputs those shot images to the printer 16, the CPU 30 divides those shot images for each user and outputs those shot images in order. Thereby, the user is not required to perform the sorting task.

Moreover, also with respect to payment of print fees, whether the print fees of all the users are paid in a lump sum or each user's print fee is paid by each user may be able to be designated on the order guidance screen on the monitor 12.

Furthermore, if the input of the print order information has been confirmed, or in the process of the input, the contents of the print order information (the number of the shot images designated to be printed, the total number of the prints, and a total amount) may be displayed for each user.

Next, an embodiment of a process of the commerce material selection (step S14) of FIG. 3 in the case where the plurality of users can select the shot images to be printed as their own print orders, respectively, as described above will be described.

For example, not only the case where each user prints the shot image designated to be printed, on an ordinary photo paper sheet, but also a case is conceivable in which there are a service (frame print) of synthesizing and printing the shot image with the frame image (template image), a service of creating a calendar with the shot image designated to be printed, a service of creating an album (photo book) with the shot image designated to be printed, and the like, and those services can be selected for each user.

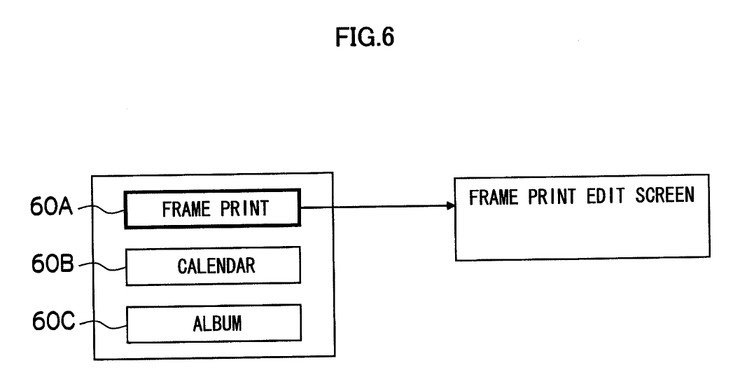

For example, on the screen of the monitor 12, as shown in FIG. 6, a service selection screen including buttons 60A, 60B and 60C with service names of “frame print”, “calendar” and “album” is displayed. Each user can touch the button of a desired service to select the service, and subsequently to the selection, the guidance screen is displayed on which the order information depending on the service is inputted.

For example, it is assumed that Mr. A, Mr. B and Mr. C have selected the shot images to be printed, as their own print order information, respectively. Among them, if it is assumed that only Mr. B has desired the frame print, only Mr. B touches the button with “frame print”. Thereby, it is determined that only Mr. B has selected the service of the frame print. In this way, it is determined that the user who has performed an operation of selecting the service has selected the service.

Then, if it is assumed that only Mr. B has selected the service of the frame print, subsequently, a frame print edit screen on which the order information required for the frame print is inputted is displayed, and the frame image (template image) is selected, or layout adjustment or the like is performed. At this time, the print ordering apparatus 10 enables only the operation by Mr. B who has selected the service, and disables operations by other users. Thereby, a defect is prevented in which a current input on the order guidance screen is mistakenly operated by a user other than the user who has selected the service.

It should be noted that, on the service selection screen of FIG. 6 on which the service is selected, if the plurality of users have touched the button of the same service, those operations by the plurality of users may be enabled on the order guidance screen for the service.

Moreover, in the case where one user has selected a predetermined service and an order guidance screen on which order information specific to the service is inputted has been displayed on the monitor 12, not only the user who has selected the service can perform the operation, but also other users may be able to perform the operations, and the operation by the user who has selected the service may be prioritized. For example, if another user has performed an operation against the operation by the user who has selected the service, the operation performed by another user is disabled or otherwise may be enabled.

Moreover, on the order guidance screen for the selected service, other users may be able to perform only some operations. For example, in the frame print, important operations such as the image selection and the template selection may be able to be performed only by the user who has selected the service, while other operations may also be able to be performed by other users.

Next, an embodiment of the commerce material selection (step S14) as described above in the case where the plurality of users have selected a service on which detailed order information is required to be inputted will be described. In the case where the plurality of users have selected the service on which the detailed order information is required to be inputted, instead of an ordinary print, the input of the detailed order information takes time if performed by those users in order. For example, several tens of pages are required to be edited in the creation of the album (photo book), which requires considerable time if performed by the plurality of users in order. Consequently, in the present embodiment, vacancy of other print ordering apparatuses placed near the print ordering apparatus 10 which has been initially used by the user is checked, and if there are any vacant (non-used) print ordering apparatuses, the plurality of users who have selected a specific time-consuming service such as the album creation are divided by the number of apparatuses which is a sum of the initial print ordering apparatus 10 and the vacant print ordering apparatuses (at most the number of users who have selected the specific service) so that as many as possible print ordering apparatuses can be used by the respective users to input the order information in parallel. Then, with respect to a user who inputs the order information in the print ordering apparatus other than the initial print ordering apparatus 10, the print order information or shot image information which has been inputted until then is transferred to the print ordering apparatus used by the user.

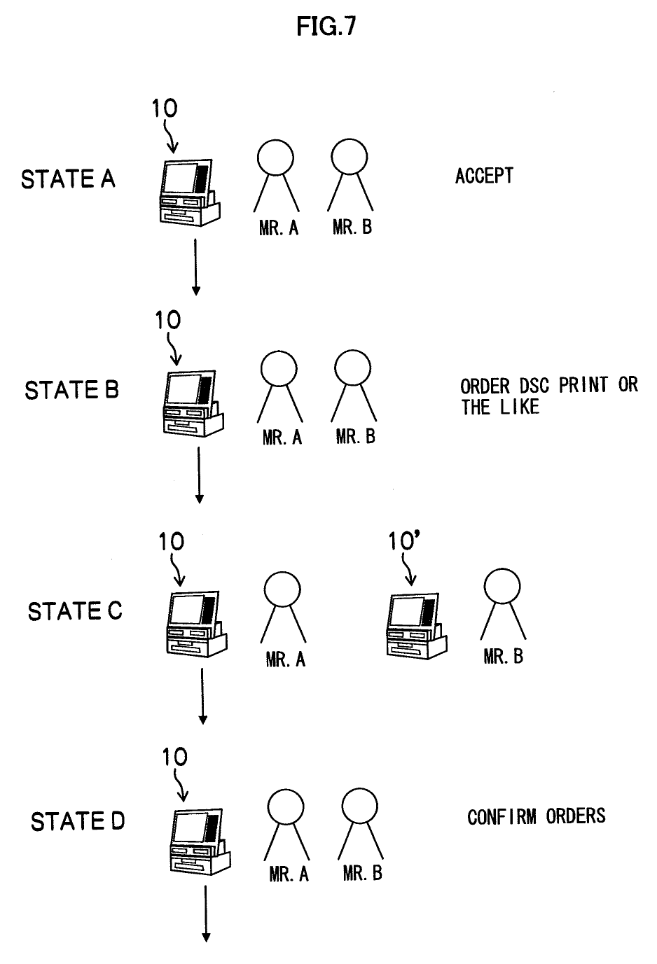

FIG. 7 is a diagram illustrating a series of operations in the case where two users, Mr. A and Mr. B, have selected the specific service. First, as shown in state A of FIG. 7, Mr. A and Mr. B load the same medium in one print ordering apparatus 10 (initial print ordering apparatus) and start acceptance of the print orders. Then, as shown in state B, in the print ordering apparatus 10, Mr. A and Mr. B perform the input operations for the order information for the ordinary print (DSC print or the like). Subsequently, if it is assumed that Mr. A and Mr. B have selected the specific service such as the album creation in the commerce material selection, the initial print ordering apparatus 10 checks the vacancy of other print ordering apparatuses. If there are any vacant print ordering apparatuses, the initial print ordering apparatus 10 transmits, for example, the print order information which has been inputted by Mr. B until then, to one print ordering apparatus 10′ among the vacant print ordering apparatuses. Then, as shown in state C, Mr. A uses the initial print ordering apparatus 10 to input the order information on the selected specific service, while Mr. B uses another print ordering apparatus 10′ to input the order information on the selected specific service. When the order information is completely inputted, the order information which has been inputted by Mr. B in the print ordering apparatus 10′ is transferred to the initial print ordering apparatus 10, and as shown in state D, subsequent necessary operations by Mr. A and Mr. B are accepted and the orders are confirmed in the initial print ordering apparatus 10.

As described above, a plurality of print ordering apparatuses can be used so as to reduce an ordering time.

Next, an embodiment related to operation cancellation will be described. During the input operation by a predetermined user among the plurality of users, if another user has interrupted and performed operations, all the operations by another user who has interrupted can be preferably canceled. Consequently, in the present embodiment, for example, the user who has operated the screen is identified by the user identification sensor 42. Moreover, an operation history of each user has been retained.

Then, for example, as the operation on the image selection screen, it is assumed that Mr. B has interrupted the operation being performed by Mr. A. Then, an immediately preceding operation by Mr. B is set to be canceled if Mr. B touches a button with “cancel the immediately preceding operation” on the screen. If Mr. B has consecutively touched this button, all the operations by Mr. B are canceled. If Mr. A has touched the button with “cancel the immediately preceding operation”, the immediately preceding operation by Mr. A is canceled. In this way, it is convenient to have set the operation cancellation in units of users.

Moreover, according to a process of this operation cancellation, if the user has asked a shop staff about the operation being performed, the shop staff can perform a demonstration in the print ordering apparatus 10 being used by the user, in order to explain the operation. After the explanation, all the operations performed by the shop staff can be canceled so as to return to a state in the middle of the operation by the user.

Hereinabove, as the above described embodiment, if the print orders from the plurality of users have been enabled, the order guidance screen may be switched for each user.

Moreover, also in a system for the shop staff instead of the print ordering person, it is convenient to enable the operations by the plurality of users, similarly to the above described embodiment. For example, in a system which creates a complicated synthesized print such as a new year's card print, tasks can be more efficiently performed by two users using one PC which supports the operations by the plurality of users, rather than performing the tasks by the two users using two PCs. For example, a shop staff A accomplishes tasks of capturing the images and performing color correction (CMYD), while a shop staff B performs tasks of synthesizing the images and inputting characters after the color correction. If such tasks can be performed in one PC, the users can see each other's tasks, and therefore, human errors can be intended to be reduced.

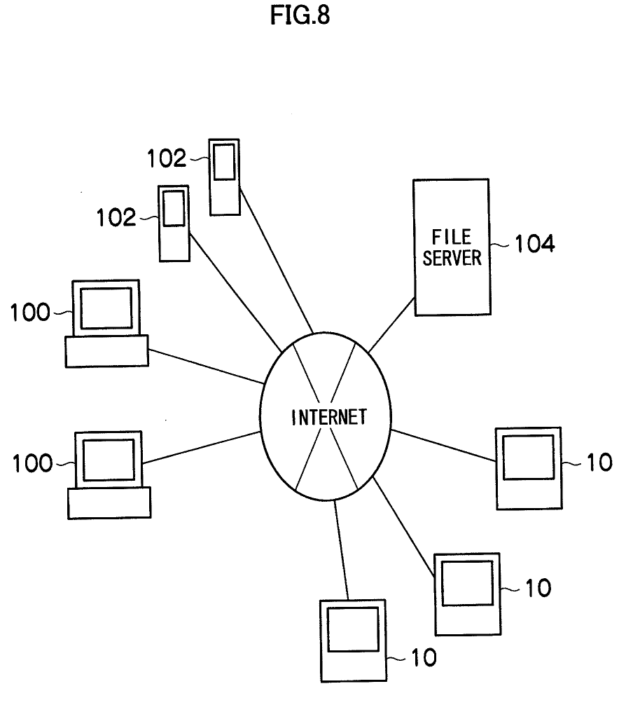

Moreover, in the above described embodiment, the medium in which the shot images have been recorded and saved is directly mounted in the print ordering apparatus 10, or the digital camera or the like in which the medium has been loaded is connected to the print ordering apparatus 10, so as to read the shot image selected by the user into the print ordering apparatus 10, which, however, is not limited thereto. For example, as shown in FIG. 8, in a system in which the print ordering apparatuses 10, 10, . . . , personal computers 100, 100, . . . , cellular phones 102, 102, . . . , a file server 104 and the like are connected to one another through the Internet, it is conceivable that the user uses a home personal computer 100 to transmit images shot by the digital camera, a cellular phone including a camera or the like to the file server 104, or transmits the images shot by the cellular phone including the camera to the file server 104, and saves the images as an online album in the file server 104. In such a case, in the print ordering apparatus 10, it is also possible to capture the images in the file server 104 through the Internet and select the image to be printed from the captured images.

Moreover, in the above described embodiment, the case has been described where the present invention has been applied to the print ordering apparatus which selects the (shot) image to be printed. However, the present invention can be applied to the case where the plurality of users can select the images in one apparatus, in an image processing apparatus which selects an image which is a processing target in an arbitrary process.

What is claimed is:

1 An image processing apparatus, comprising:
a monitor which displays various information;
an input device with which a user performs an input operation;
an identification device which identifies the user who has performed the input operation with the input device;
an image reading device which reads images;
an image selection device which, according to the input operation with the input device, selects an image which is a predetermined processing target, from the images read by the image reading device, the image selection device identifying a plurality of users who have performed input operations for selecting images, by the identification device, and selecting the image which is the processing target, for each of the users who have performed the input operations for selecting the images; and
a processing device which executes a process with the image selected by the image selection device as the processing target.

2. The image processing apparatus according to claim 1, wherein the process with the image selected for each of the users as the processing target is divided and executed for each user.

3. The image processing apparatus according to claim 1, wherein, at the time of an input operation with respect to an image selected by a predetermined user, the input operation by a user other than the predetermined user is disabled or limited to certain operation contents.

4. The image processing apparatus according to claim 2, wherein, at the time of an input operation with respect to an image selected by a predetermined user, the input operation by a user other than the predetermined user is disabled or limited to certain operation contents.

5. The image processing apparatus according to claim 1, wherein if each user needs to perform the input operation separately, information which has been already inputted with respect to some of the users is transmitted to another image processing apparatus which is not currently used, and the input operations by the some of the users are executed in another image processing apparatus.

6. The image processing apparatus according to claim 4, wherein if each user needs to perform the input operation separately, information which has been already inputted with respect to some of the users is transmitted to another image processing apparatus which is not currently used, and the input operations by the some of the users are executed in another image processing apparatus.

7. The image processing apparatus according to claim 1, wherein operations by the plurality of users can be canceled for each user.

8. The image processing apparatus according to claim 6, wherein operations by the plurality of users can be canceled for each user.

9. The image processing apparatus according to claim 1, further comprising, as the input device, a touch panel which is installed on a screen of the monitor and detects a touch operation with respect to the screen of the monitor.

10. The image processing apparatus according to claim 8, further comprising, as the input device, a touch panel which is installed on a screen of the monitor and detects a touch operation with respect to the screen of the monitor.

11. The image processing apparatus according to claim 1, wherein the processing device executes a process of accepting a print order for the image selected by the image selection device.

12. The image processing apparatus according to claim 10, wherein the processing device executes a process of accepting a print order for the image selected by the image selection device.

13. An image selection method in an image processing apparatus including a monitor which displays various information, an input device with which a user performs an input operation, an identification device which identifies the user who has performed the input operation with the input device, an image reading device which reads images, an image selection device which, according to the input operation with the input device, selects an image which is a predetermined processing target, from the images read by the image reading device, and a processing device which executes a process with the image selected by the image selection device as the processing target, wherein:
at the time of selecting the image by the image selection device, a plurality of users who have performed input operations for selecting images are identified by the identification device, and the image which is the processing target is selected for each of the users who have performed the input operations for selecting the images.

14. The image selection method according to claim 13, wherein the process with the image selected for each of the users as the processing target is divided and executed for each user.

15. The image selection method according to claim 13, wherein, at the time of an input operation with respect to an image selected by a predetermined user, the input operation by a user other than the predetermined user is disabled or limited to certain operation contents.

16. The image selection method according to claim 14, wherein, at the time of an input operation with respect to an image selected by a predetermined user, the input operation by a user other than the predetermined user is disabled or limited to certain operation contents.

17. The image selection method according to claim 13, wherein if each user needs to perform the input operation separately, information which has been already inputted with respect to some of the users is transmitted to another image processing apparatus which is not currently used, and the input operations by the some of the users are executed in another image processing apparatus.

18. The image selection method according to claim 16, wherein if each user needs to perform the input operation separately, information which has been already inputted with respect to some of the users is transmitted to another image processing apparatus which is not currently used, and the input operations by the some of the users are executed in another image processing apparatus.

19. The image selection method according to claim 13, wherein operations by the plurality of users can be canceled for each user.

20. The image selection method according to claim 18, wherein operations by the plurality of users can be canceled for each user.

21. The image selection method according to claim 13, further comprising, as the input device, a touch panel which is installed on a screen of the monitor and detects a touch operation with respect to the screen of the monitor.

22. The image selection method according to claim 20, further comprising, as the input device, a touch panel which is installed on a screen of the monitor and detects a touch operation with respect to the screen of the monitor.

23. The image selection method according to claim 13, wherein the processing device executes a process of accepting a print order for the image selected by the image selection device.

24. The image selection method according to claim 22, wherein the processing device executes a process of accepting a print order for the image selected by the image selection device.
